(19) United States
(12) Patent Application Publication
(10) Pub. No.: US 2026/0313495 A1
(43) Pub. Date: Oct. 8, 2026

(54) METHOD AND APPARATUS FOR HANDLING TCI STATE AND BWP FOR LOWER LAYER SIGNAL BASED MOBILITY IN WIRELESS COMMUNICATION SYSTEM

(71) Applicant: SAMSUNG ELECTRONICS CO., LTD., Suwon-si, Gyeonggi-do (KR)

(72) Inventors: Anil AGIWAL, Suwon-si (KR); Seungri JIN, Suwon-si (KR)

(21) Appl. No.: 19/122,204

(22) PCT Filed: Oct. 18, 2023
(86) PCT No.: PCT/KR2023/016141

§ 371 Date: Apr. 17, 2025

(30) Foreign Application Priority Data
Oct. 20, 2022 (KR) 10-2022-0135860

(51) Int. Cl. H04W 36/08; H04W 36/00

(52) U.S. Cl. CPC H04W 36/08; H04W 36/0072

(57) ABSTRACT

The disclosure relates to a 5G or 6G communication system for supporting a higher data transmission rate. A method performed by a terminal in a wireless communication system is provided. The method includes receiving, from a base station, a control message including a configuration of a target cell for a lower layer based mobility; receiving, from the base station, a lower layer triggered mobility (LTM) cell change command to switch to the target cell, the LTM cell change command including information on a transmission configuration indicator (TCI) state; and upon determining to perform a random access procedure to the target cell, selecting a random access channel (RACH) resource corresponding to the TCI state and applying the TCI state for a physical downlink control channel (PDCCH) monitoring during the random access procedure.

### TECHNICAL FIELD

The disclosure relates to a wireless communication system. More particularly, the disclosure relates to an apparatus, a method and a system for handling TCI states and BWPs for a lower layer signal based mobility.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

As technology progresses to lower layer mobility, the L1/L2 Cell change command may include a TCI state for PDCCH monitoring. Upon receiving L1/L2 Cell change command, several issues related to handling of received TCI state need to be addressed, such as determining the precise moment the UE should apply this parameter. Another question that surfaces is whether the UE, based on this TCI state, would choose the RACH resource if a RACH process is initiated post receiving the L1/L2 Cell change command. Moreover, upon the UE's reception of the L1/L2 cell change command, there exists ambiguity regarding the selection of DL/UL BWPs, raising the question of the specific BWP(s) the UE would employ in the target cell.

### Solution to Problem

In accordance with an aspect of the disclosure, a method performed by a terminal in a wireless communication system is provided. The method includes receiving, from a base station, a control message including a configuration of a target cell for a lower layer based mobility; receiving, from the base station, a lower layer triggered mobility (LTM) cell change command to switch to the target cell, the LTM cell change command including information on a transmission configuration indicator (TCI) state; and upon determining to perform a random access procedure to the target cell, selecting a random access channel (RACH) resource corresponding to the TCI state and applying the TCI state for a physical downlink control channel (PDCCH) monitoring during the random access procedure.

In accordance with another aspect of the disclosure, a method performed by a base station in a wireless communication system is provided. The method includes transmitting, to a terminal, a control message including a configuration of a target cell for a lower layer based mobility; and transmitting, to the terminal, an LTM cell change command to switch to the target cell, the LTM cell change command including information on a TCI state. If a random access procedure to the target cell is performed, the TCI state corresponds to a RACH resource for the random access procedure and the TCI state is applied for a PDCCH monitoring during the random access procedure.

In accordance with another aspect of the disclosure, a terminal in a wireless communication system is provided. The terminal includes a transceiver and a controller. The controller is configured to receive, from a base station via the transceiver, a control message including a configuration of a target cell for a lower layer based mobility, receive, from the base station via the transceiver, an LTM cell change command to switch to the target cell, the LTM cell change command including information on a TCI state, and upon determining to perform a random access procedure to the target cell, select a RACH resource corresponding to the TCI state and apply the TCI state for a PDCCH monitoring during the random access procedure.

In accordance with another aspect of the disclosure, a base station in a wireless communication system is provided. The base station includes a transceiver and a controller. The controller is configured to transmit, to a terminal via the transceiver, a control message including a configuration of a target cell for a lower layer based mobility, and transmit, to the terminal via the transceiver, an LTM cell change command to switch to the target cell, the LTM cell change command including information on a TCI state. If a random access procedure to the target cell is performed, the TCI state corresponds to a RACH resource for the random access procedure and the TCI state is applied for a PDCCH monitoring during the random access procedure.

### Advantageous Effects of Invention

The disclosure provides effective solutions to challenges faced in lower layer mobility in a wireless communication system. In one embodiment, the timing for the UE to apply the TCI state upon receiving the L1/L2 Cell change command can be defined. Additionally, the disclosure proposes how the UE select RACH resources based on the TCI state after a RACH process is initiated and how to select the appropriate DL/UL BWPs in the target cell, thereby eliminating ambiguity.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a signaling procedures for an inter-gNB handover according to an embodiment of the disclosure;

FIG. 2 illustrates an example of TCI state/BWP handing in a lower layer based mobility procedure according to an embodiment of the disclosure;

FIG. 3 illustrates an example of TCI state/BWP handing in a lower layer based mobility procedure according to an embodiment of the disclosure;

FIG. 4 illustrates an example of TCI state/BWP handing in a lower layer based mobility procedure according to an embodiment of the disclosure;

FIG. 5 illustrates a block diagram of a terminal according to an embodiment of the disclosure; and

FIG. 6 illustrates a block diagram of a base station according to an embodiment of the disclosure.

Throughout the drawings, like reference numerals will be understood to refer to like parts, components, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is known to those skilled in the art that blocks of a flowchart (or sequence diagram) and a combination of flowcharts may be represented and executed by computer program instructions. These computer program instructions may be loaded on a processor of a general purpose computer, special purpose computer, or programmable data processing equipment. When the loaded program instructions are executed by the processor, they create a means for carrying out functions described in the flowchart. Because the computer program instructions may be stored in a computer readable memory that is usable in a specialized computer or a programmable data processing equipment, it is also possible to create articles of manufacture that carry out functions described in the flowchart. Because the computer program instructions may be loaded on a computer or a programmable data processing equipment, when executed as processes, they may carry out operations of functions described in the flowchart.

A block of a flowchart may correspond to a module, a segment, or a code containing one or more executable instructions implementing one or more logical functions, or may correspond to a part thereof. In some cases, functions described by blocks may be executed in an order different from the listed order. For example, two blocks listed in sequence may be executed at the same time or executed in reverse order.

In this description, the words “unit”, “module” or the like may refer to a software component or hardware component, such as, for example, a field-programmable gate array (FPGA) or an application-specific integrated circuit (ASIC) capable of carrying out a function or an operation. However, a “unit”, or the like, is not limited to hardware or software. A unit, or the like, may be configured so as to reside in an addressable storage medium or to drive one or more processors. Units, or the like, may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of smaller components and units, and may be combined with others to compose larger components and units. Components and units may be configured to drive a device or one or more processors in a secure multimedia card.

Prior to the detailed description, terms or definitions necessary to understand the disclosure are described. However, these terms should be construed in a non-limiting way.

The “base station (BS)” is an entity communicating with a user equipment (UE) and may be referred to as BS, base transceiver station (BTS), node B (NB), evolved NB (eNB), access point (AP), 5G NB (5gNB), or gNB.

The “UE” is an entity communicating with a BS and may be referred to as UE, device, mobile station (MS), mobile equipment (ME), or terminal.

In the recent years, several broadband wireless technologies have been developed to meet the growing number of broadband subscribers and to provide more and better applications and services. The second-generation wireless communication system has been developed to provide voice services while ensuring the mobility of users. Third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. So fifth generation wireless communication system (also referred as next generation radio or NR) is being developed to meet the growing demand for high speed data services, support ultra-reliability and low latency applications.

The fifth generation wireless communication system supports not only lower frequency bands but also in higher frequency (mmWave) bands, e.g., 10 GHz to 100 GHz bands, so as to accomplish higher data rates. To mitigate propagation loss of the radio waves and increase the transmission distance, the beamforming, massive Multiple-Input Multiple-Output (MIMO), Full Dimensional MIMO (FD-MIMO), array antenna, an analog beam forming, large scale antenna techniques are being considered in the design of fifth generation wireless communication system. In addition, the fifth generation wireless communication system is expected to address different use cases having quite different requirements in terms of data rate, latency, reliability, mobility etc. However, it is expected that the design of the air-interface of the fifth generation wireless communication system would be flexible enough to serve the UEs having quite different capabilities depending on the use case and market segment the UE cater service to the end customer. Few examples of use cases in the fifth generation wireless communication system wireless system that are expected to address are enhanced Mobile Broadband (eMBB), massive Machine Type Communication (m-MTC), ultrareliable low latency communication (URLLC) etc. The eMBB requirements like tens of Gbps data rate, low latency, high mobility so on and so forth address the market segment representing the conventional wireless broadband subscribers needing internet connectivity everywhere, all the time and on the go. The m-MTC requirements like very high connection density, infrequent data transmission, very long battery life, low mobility address so on and so forth address the market segment representing the Internet of Things (IoT)/Internet of Everything (IoE) envisioning connectivity of billions of devices. The URLL requirements like very low latency, very high reliability and variable mobility so on and so forth address the market segment representing the Industrial automation application, vehicle-to-vehicle/vehicle-to-infrastructure communication foreseen as one of the enablers for autonomous cars.

In the fifth generation wireless communication system operating in higher frequency (mmWave) bands, UE and gNB communicates with each other using Beamforming. Beamforming techniques are used to mitigate the propagation path losses and to increase the propagation distance for communication at higher frequency band. Beamforming enhances the transmission and reception performance using a high-gain antenna. Beamforming can be classified into Transmission (TX) beamforming performed in a transmitting end and reception (RX) beamforming performed in a receiving end. In general, the TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of the TX beamforming results in the increase in the directivity of a signal, thereby increasing a propagation distance. Further, since the signal is almost not transmitted in a direction other than a directivity direction, a signal interference acting on another receiving end is significantly decreased. The receiving end can perform beamforming on a RX signal by using a RX antenna array. The RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming technique, a transmitter can make plurality of transmit beam patterns of different directions. Each of these transmit beam patterns can be also referred as transmit (TX) beam. Wireless communication system operating at high frequency uses plurality of narrow TX beams to transmit signals in the cell as each narrow TX beam provides coverage to a part of cell. The narrower the TX beam, higher is the antenna gain and hence the larger the propagation distance of signal transmitted using beamforming. A receiver can also make plurality of receive (RX) beam patterns of different directions. Each of these receive patterns can be also referred as receive (RX) beam.

The fifth generation wireless communication system, supports standalone mode of operation as well dual connectivity (DC). In DC a multiple Rx/Tx UE may be configured to utilise resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilise radio resources provided by two distinct schedulers, located in two different nodes connected via a non-ideal backhaul and providing either evolved-universal terrestrial radio access (E-UTRA) (i.e. if the node is an ng-eNB) or NR access (i.e. if the node is a gNB). In NR for a UE in RRC_CONNECTED not configured with CA/DC there is only one serving cell comprising of the primary cell. For a UE in RRC_CONNECTED configured with carrier aggregation (CA)/DC the term ‘serving cells’ is used to denote the set of cells comprising of the Special Cell(s) (SpCell(s)) and all secondary cells. In NR the term Master Cell Group (MCG) refers to a group of serving cells associated with the Master Node, comprising of the PCell and optionally one or more SCells. In NR the term Secondary Cell Group (SCG) refers to a group of serving cells associated with the Secondary Node, comprising of the PSCell and optionally one or more SCells. In NR primary cell (PCell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

In the fifth generation wireless communication system, Physical Downlink Control Channel (PDCCH) is used to schedule DL transmissions on physical downlink shared channel (PDSCH) and UL transmissions on physical uplink shared channel (PUSCH), where the Downlink Control Information (DCI) on PDCCH includes: Downlink assignments containing at least modulation and coding format, resource allocation, and hybrid-automatic repeat request (HARQ) information related to DL-SCH; Uplink scheduling grants containing at least modulation and coding format, resource allocation, and HARQ information related to UL-SCH. In addition to scheduling, PDCCH can be used to for: Activation and deactivation of configured PUSCH transmission with configured grant; Activation and deactivation of PDSCH semipersistent transmission; Notifying one or more UEs of the slot format; Notifying one or more UEs of the physical resource block(s) (PRB(s)) and orthogonal frequency-division multiplexing (OFDM) symbol(s) where the UE may assume no transmission is intended for the UE; Transmission of transmit power control (TPC) commands for physical uplink control channel (PUCCH) and PUSCH; Transmission of one or more TPC commands for SRS transmissions by one or more UEs; Switching a UE's active bandwidth part; Initiating a random access procedure. A UE monitors a set of PDCCH candidates in the configured monitoring occasions in one or more configured Control REsource SETs (CORESETs) according to the corresponding search space configurations. A CORESET consists of a set of PRBs with a time duration of 1 to 3 OFDM symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET. Polar coding is used for PDCCH. Each resource element group carrying PDCCH carries its own demodulation reference signal (DMRS). Quadrature phase shift keying (QPSK) modulation is used for PDCCH.

In fifth generation wireless communication system, a list of search space configurations are signaled by gNB for each configured BWP wherein each search configuration is uniquely identified by an identifier. Identifier of search space configuration to be used for specific purpose such as paging reception, SI reception, random access response reception is explicitly signaled by gNB. In NR search space configuration comprises of parameters Monitoring-periodicity-PDCCH-slot, Monitoring-offset-PDCCH-slot, Monitoring-symbols-PDCCH-within-slot and duration. A UE determines PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are there in slots ‘x’ to x+duration where the slot with number ‘x’ in a radio frame with number ‘y’ satisfies the equation below:

(y*(number of slots in a radio frame)+x-Monitoring-offset-PDCCH-slot)mod(Monitoring-periodicity-PDCCH-slot)=0;

The starting symbol of a PDCCH monitoring occasion in each slot having PDCCH monitoring occasion is given by Monitoring-symbols-PDCCH-within-slot. The length (in symbols) of a PDCCH monitoring occasion is given in the corset associated with the search space. Search space configuration includes the identifier of coreset configuration associated with it. A list of coreset configurations are signaled by gNB for each configured BWP wherein each coreset configuration is uniquely identified by an identifier. Note that each radio frame is of 10 ms duration. Radio frame is identified by a radio frame number or system frame number. Each radio frame comprises of several slots wherein the number of slots in a radio frame and duration of slots depends on sub carrier spacing. The number of slots in a radio frame and duration of slots depends radio frame for each supported SCS is pre-defined in NR. Each coreset configuration is associated with a list of Transmission configuration indicator (TCI) states. One DL RS ID (SSB or CSI RS) is configured per TCI state. The list of TCI states corresponding to a coreset configuration is signaled by gNB via radio resource control (RRC) signaling. One of the TCI state in TCI state list is activated and indicated to UE by gNB via a medium access control (MAC) control element (CE). TCI state indicates the DL TX beam (DL TX beam is QCLed with SSB/CSI RS of TCI state) used by gNB for transmission of PDCCH in the PDCCH monitoring occasions of a search space. For PDSCH, TCI state of scheduling PDCCH can be used for scheduled PDSCH. Alternately, TCI state of the PDCCH for the lowest corset ID in the slot is used for PDSCH. Alternately combination of RRC+MAC CE+DCI is used to indicate the TCI state for PDSCH. RRC configures a list of TCI state, MAC CE indicates a subset of these TCI states and DCI indicates one of the TCI state from list of TCI states indicated in MAC CE.

In fifth generation wireless communication system bandwidth adaptation (BA) is supported. With BA, the receive and transmit bandwidth of a UE need not be as large as the bandwidth of the cell and can be adjusted: the width can be ordered to change (e.g. to shrink during period of low activity to save power); the location can move in the frequency domain (e.g. to increase scheduling flexibility); and the subcarrier spacing can be ordered to change (e.g. to allow different services). A subset of the total cell bandwidth of a cell is referred to as a Bandwidth Part (BWP). BA is achieved by configuring RRC connected UE with BWP(s) and telling the UE which of the configured BWPs is currently the active one. When BA is configured, the UE only has to monitor PDCCH on the one active BWP i.e. it does not have to monitor PDCCH on the entire DL frequency of the serving cell. In RRC connected state, UE is configured with one or more DL and UL BWPs, for each configured Serving Cell (i.e. PCell or SCell). For an activated Serving Cell, there is always one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwpInactivity Timer, by RRC signaling, or by the media access control (MAC) entity itself upon initiation of Random Access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer UE switch to the active DL BWP to the default DL BWP or initial DL BWP (if default DL BWP is not configured).

In the 5G system's architectural framework, a notable development is the split options of the gNB's internal structure into two components: a Central Unit (CU) and a Distributed Unit (DU). These components are interconnected through an F1 interface. While the partitioning can theoretically occur at any layer within the protocol stack, splitting between RLC and PDCP layers may be preferred. This option may allow traffic aggregation from NR and E-UTRA transmission points to be centralized and facilitate the management of traffic load between NR and E-UTRA transmission points.

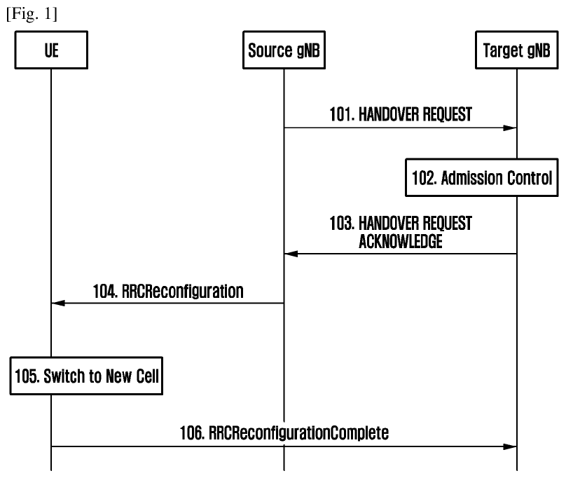

FIG. 1 illustrates a signaling procedures for an inter-gNB handover according to an embodiment of the disclosure.

In in fifth generation wireless communication system, there are two types of mobility: cell level mobility and beam level mobility. The cell level mobility may require an explicit RRC signaling to be triggered, i.e. handover command.

Referring to FIG. 1, in operation 101, a source gNB may initiate a handover and issue a HANDOVER REQUEST over the Xn interface. In operation 102, a target gNB may perform an admission control. In operation 103, the target gNB may provide a new RRC configuration as part of a HANDOVER REQUEST ACKNOWLEDGE. In operation 104, the source gNB may provide the RRC configuration to a UE by forwarding an RRCReconfiguration message received in the HANDOVER REQUEST ACKNOWLEDGE. The RRCReconfiguration message may include at least cell identifier (ID) and information required to access the target cell (target gNB) so that the UE can access the target cell without reading system information. For some cases, the information required for a contention-based and/or a contention-free random access can be included in the RRCReconfiguration message. The access information to the target cell may include beam specific information, if any. In operation 105, the UE may switch to the new cell (i.e., target cell). moving the RRC connection to the target gNB. In operation 106, the UE may reply to the target gNB with an RRCReconfigurationComplete message. Several types of handover, normal handover, conditional handover and DAPS handover can be supported in the disclosure.

Beam Level Mobility may not require explicit RRC signalling to be triggered. The gNB may provide the UE with a measurement configuration for serving cell via RRC signalling. The measurement configuration may contain configurations of synchronization signal block (SSB)/channel state information reference signal (CSI-RS) resources and resource sets, reports and trigger states for triggering channel and interference measurements and reports. Beam Level Mobility can be handled at lower layers by physical (PHY) layer and/or MAC layer control signalling, and the RRC layer may not be required to know which beam is being used at a given point in time. Based on the physical layer and/or MAC layer control signalling, the UE can be switched from one beam to another in the serving cell.

Lower Layer Mobility is a new type of lower layer mobility also referred as L1/L2-triggered mobility or lower layer triggered mobility (LTM) being investigated. The Lower Layer Mobility may be based on L1 measurements that are provided by the UE to the serving cell. Based on these measurements, handover may be triggered by sending an L1 (e.g. DCI) or L2 (e.g. MAC CE) command. In Lower Layer Mobility, the serving cell change may be triggered based on L1 beam measurements instead of L3 cell power and quality measurements that are configured in NR baseline handover of Release 15. L3 cell quality measurements may be reported only after a certain Time-to-Trigger (TTT) has expired for a measurement event. L3 measurements may also be filtered based on an L3 configuration over multiple measurements before reporting. L1 measurements may have the benefit that the network can react more quickly to radio link degradation on the serving link as the network can save the delay caused by L3 filtering and TTT for the handover decision. This should result in reducing in the number of radio link failures compared to baseline handover.

In the legacy handover, the RRC procedure delay consists of RRC signal processing related to decoding of the handover command and L2/3 reconfiguration of the protocol layers. For lower layer mobility, the RRC procedure delay can be reduced as the UE can receive and decode the configuration of the target cells before the cell change occurs. Furthermore, since lower layer mobility is restricted to the intra-CU scenario with the same PDCP and RRC layers, L2/3 reconfigurations can be minimized by keeping the same configuration for PDCP and RRC layers and possibly other layers, such as RLC and MAC layers, in the intra-DU scenario. For example, in the inter-DU scenario the new target cell may have different configurations for RLC and MAC layers. In the best case for intra-DU, the target cell can reconfigure only the new cell-radio network temporary identifier (C-RNTI) which can save the entire L2/3 reconfiguration for the UE.

In legacy handover there can be delays due to the RF/baseband retuning, derivation of target gNB security keys and the configuration of the security algorithm to be used in the target cell. These can also be avoided in lower layer mobility. As the PDCP entity in the CU is the same for both source and target cells, the same security keys and algorithms can be applied which reduces the interruption time.

In the legacy handover there can be an interruption due to the uncertainty of acquiring the first available physical random access channel (PRACH) occasion in the new cell. In addition, there can be interruptions of sending the PRACH preamble and receiving the RACH response (RAR). These random access related interruption components can be reduced in Lower Layer Mobility by introducing RACH-less handover, where the UE can skip the entire random-access procedure to the target cell. For scenarios where the RACH-less handover cannot be applied, the UE may acquire the timing advance of the prepared target cells before the actual handover occurs.

As technology progresses to lower layer mobility, the L1/L2 Cell change command may include a TCI state for PDCCH monitoring. Upon receiving L1/L2 Cell change command, several issues related to handling of received TCI state need to be addressed, such as determining the precise moment the UE applies this parameter. Another question that surfaces is whether the UE, based on this TCI state, would choose the RACH resource if a RACH process is initiated post receiving the L1/L2 Cell change command. Moreover, upon the UE's reception of the L1/L2 cell change command, there exists ambiguity regarding the selection of DL/UL BWPs, raising the question of the specific BWP(s) the UE would employ in the target cell.

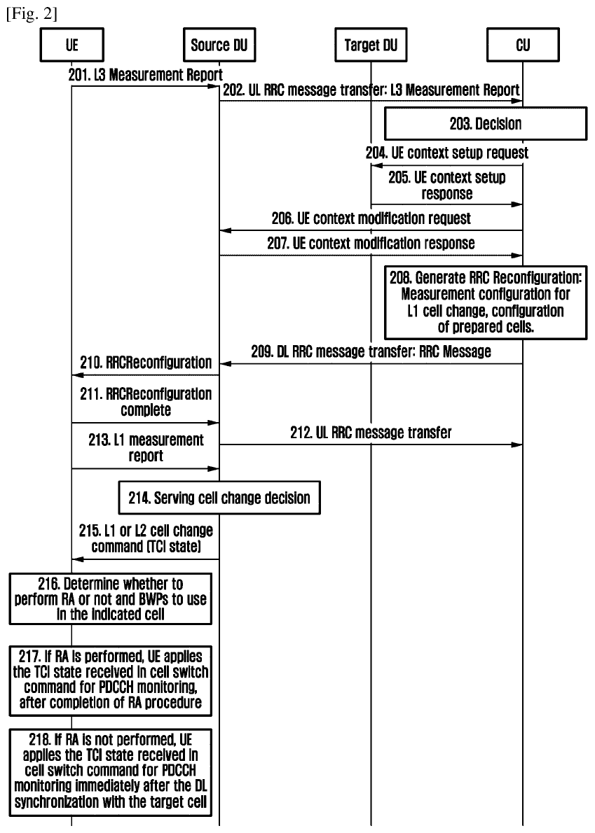

FIG. 2 illustrates an example of TCI state/BWP handing in a lower layer based mobility procedure according to an embodiment of the disclosure.

A UE may send measurement report(s) containing the measurements of serving and target cell(s) in operations 201 and 202. The measurement report may be sent to the serving cell. A serving DU (i.e., source DU) of the serving cell then may forward the report(s) to a CU.

Based on the reported measurements, the CU may identify a potential set of candidate target cells to which the UE can be handed over to, in operation 203. In this example, the CU may identify one or more candidate target cells where the candidate target cell is served by either the source DU or another DU (i.e., target DU) which are controlled by the same CU.

The CU may request the preparation of a candidate target cell controlled by the target DU by sending UE Context Setup Request message, in operation 204. The target DU may provide the configuration of the UE in UE Context Setup Response messages, respectively in operation 205. Each message may include a container from DU to CU. The configuration may contain UE-specific and non-UE-specific parts. In an embodiment, operation 204 and operation 205 may not be performed if candidate target cells of the other DU are not identified in operation 203.

The CU may request the preparation of a candidate target cell controlled by the source DU by sending UE Context Modification Request message in operation 206. The source DU may provide the configuration of the UE in UE Context Modification Response message including a container from DU to CU in operation 207. The configuration may contain UE-specific and non-UE-specific parts. In an embodiment, operation 206 and operation 207 may not be performed if candidate target cells of the source DU are not identified in operation 203.

Upon receiving the UE configurations for the candidate target cell(s), the CU may generate an RRC Reconfiguration (in operation 208) to be sent to the UE in operations 209 and 210. The CU may send the configuration to the source DU which then sends the configuration to the UE. Among other information, the RRC Reconfiguration message contains at least one of: Measurement reporting configuration for L1/L2 mobility (i.e., configuration on how to report the L1 beam measurements of serving and target cells); Configuration of the prepared candidate cell(s) which the UE needs to execute when the UE receives a L1/L2 command to change the serving cell, such as random access configuration; radio bearer configurations; indication of whether to perform a PDCP re-establishment or not (per DRB or common for all); indication of whether to perform a PDCP level data recovery or not (per DRB or common for all); indication of whether to perform an RLC re-establishment or not (per DRB or RLC channel or common for all); indication of whether to perform a MAC reset or partial MAC reset or not, etc. The RRC Reconfiguration may also include firstActiveUplinkBWP and firstActiveDownlinkBWP for each prepared candidate cell(s) and a list of DL and UL BWP configurations for each prepared candidate cell(s). The RRC Reconfiguration may also include InitialUplinkBWP and InitialDownlinkBWP for each prepared candidate cell(s) and a list of DL and UL BWP configurations for each prepared candidate cell(s).

The UE may confirm the RRC Reconfiguration to the network in operations 211 and 212.

After confirming the RRC Reconfiguration to the network, the UE may start to report the L1 beam measurement of the serving cell and candidate target cells in operation 213. Based on the measurements, the serving cell may decide to trigger a cell change command in operation 214. In an example, upon determining that there is a target candidate cell having a better radio link/beam measurement than the serving cell (operation 214), e.g., L1-RSRP of target beam measurement>L1-RSRP of serving beam measurement+Offset for a time period (i.e. Time-to-Trigger (TTT) period), the serving cell may send an L1 or L2 cell change/switch command in operation 215 to trigger the cell change to the target candidate cell. In an embodiment, the L1 or L2 cell change/switch command may be a MAC CE or DCI. The cell switch/change command may include a TCI state for monitoring a PDCCH in target cell. The TCI state may be determined by the serving cell/DU or serving CU in operation 214. Alternately, the TCI state may be decided by the target cell/DU and informed to the serving cell/DU. In operation 216, the UE may determine whether to perform a random access (RA) towards the target cell indicated in the L1 or L2 cell change/switch command and may determine DL/UL BWP(s) to be used for DL/UL reception/transmission in the target cell. In operation 217, if the UE determines to perform the RA, the UE may apply the TCI state received in the L1 or L2 cell switch command for PDCCH monitoring after the completion of the random access procedure. In operation 218, if the UE determines not to perform the RA, the UE may apply the TCI state received in the L1 or L2 cell switch command for PDCCH monitoring after or immediately after the DL synchronization with the target cell (or the UE may apply the TCI state received in the L1 or L2 cell switch command for PDCCH monitoring after receiving the cell switch command).

More specifically, operations 216 through 218 are described in detail below.
(Condition 1) In an embodiment, if a timing advance (TA) was maintained by the UE for the target cell before the L1/L2 cell switch change/command is received and a time alignment timer (TAT) for a timing advance group (TAG) of the target cell is not running; or
(Condition 2) In an embodiment, if the RRCReconfiguration message received in operation 210 or L1/L2 cell switch/change command received in operation 215 includes an indication to perform a random access (RA) towards the target cell; or
(Condition 3): In an embodiment, if the L1/L2 cell switch/change command received in operation 215 does not include a TA of the target cell and the UE does not have a valid TA (e.g. TA received from the network before the L1/L2 cell switch/change command or estimated by UE) of the target cell:
   The UE may perform the RA procedure towards the target cell (during the RA, the UE may select the RACH resource corresponding to the suitable SSB or suitable SSB/CSI RS in case of CFRA).
   The UE may apply the TCI state received in the L1/L2 cell switch command for PDCCH monitoring, after completion of the RA procedure.
Else (if Conditions 1, 2, and 3 are not satisfied or the UE has a valid TA for the target cell):
   The UE may apply the TCI state received in the cell switch command for PDCCH monitoring after or immediately after the DL synchronization with the target cell or after receiving the cell switch command.

In an embodiment, the indication to perform the RA in operation 210 may be presence of ReconfigurationwithSync IE or a new indication in SpCellConfig.

Upon receiving the L1 or L2 cell switch/change command, for the target cell (i.e. the cell to which the UE switches) the UE may determine the active DL/UL BWP as follows:

### <Option 1>:

The UE may use the BWPs corresponding to BWP IDs indicated by fields firstActiveUplinkBWP and firstActiveDownlinkBWP included in the configuration of target cell received in operation 210. The BWP configuration of BWPs indicated by fields firstActiveUplinkBWP and firstActiveDownlinkBWP can also be provided in the configuration of target cell received in operation 210.
If firstActiveUplinkBWP is not configured/included in the configuration of target cell received in operation 210, the UE may use the initialUplinkBWP configured/included in the configuration of target cell received in operation 210.
If firstActiveUplinkBWP is not configured/included in the configuration of target cell received in operation 210, the UE may use the initialUplinkBWP configured/included in the configuration of target cell received in operation 210.
If a RACH is to be performed on the target cell and firstActiveUplinkBWP is not configured with RACH occasions, the UE may use the UL BWP indicated by initialUplinkBWP and the DL BWP indicated by initialDownlinkBWP (if firstActiveDownlinkBWP is not the same as initialDownlinkBWP), wherein fields initialUplinkBWP and initialDownlinkBWP are included in the configuration of target cell received in operation 210.

### <Option 2>

The DL/UL BWPs (BWP ids) to be used may be indicated in the L1/L2 cell change/switch command. The UE may use the indicated BWPs in the target cell. The BWP configuration of BWPs indicated by the L1/L2 cell change/switch command may be provided in the configuration of target cell received in operation 210.

### <Option 3>

The DL/UL BWPs (BWP ids) to be uses may be optionally indicated in the L1/L2 cell change/switch command. The BWP configuration of BWPs indicated by the L1/L2 cell change/switch command may be provided in the configuration of target cell received in operation 210.
If Uplink BWP ID is not present in L1/L2 cell change/switch command:
   The UE may use the BWP indicated by field firstActiveUplinkBWP in the configuration of target cell received in operation 210.
   If firstActiveUplinkBWP is not configured/included in the configuration of target cell received in operation 210, the UE may use the initialUplinkBWP configured/included in the configuration of target cell received in operation 210.
Else:
   The UE may use the UL BWP indicated in L1/L2 cell change/switch command.
If Downlink BWP ID is not present in L1/L2 cell change/switch command:
   The UE may use the BWP indicated by field firstActiveDownlinkBWP in the configuration of target cell received in operation 210.
   If firstActiveDownlinkBWP is not configured/included in the configuration of target cell received in operation 210, the UE may use the initialDownlinkBWP configured/included in the configuration of target cell received in operation 210.
Else:
   The UE may use the UL BWP indicated in the L1/L2 cell change/switch command.

In an embodiment, at least one of: the indication of whether to perform the PDCP reestablishment or not; the indication of whether to perform the PDCP level data recovery or not; indication of whether to perform the RLC re-establishment or not the indication of whether to perform the MAC reset or partial MAC reset or not, may be included in the L1/L2 cell change/switch command for target cell. Based on the indication, the UE may perform the operation as indicated when executing the L2/L2 cell change/switch command.

In an embodiment, the partial MAC reset may be indicated in the RRC or L1/L2 cell change/switch command. The partial MAC reset operation upon receiving the L1/L2 cell change/switch command is listed in Table 1 below.

TABLE 1

| Partial MAC reset | Action upon L1/L2 cell change/switch |
|---|---|
| operation | command if partial MAC reset is indicated |
| initialization of Bj for | Not needed |
| each logical channel | |
| timeAlignmentTimers | No need to stop. Assumption is that timing is |
| | same between (old) serving cell to the target |
| | cell. Otherwise, UE need to stop, e.g. if UE |
| | performs RA towards the target cell upon |
| | receiving L1/L2 cell change/switch command. |
| ongoing RACH | May be stopped and MsgA/Msg3 buffer may |
| procedure | be flushed. |
| triggered Scheduling | No need to cancel |
| Request procedure | |
| triggered Buffer Status | No need to cancel |
| Reporting procedure | |
| triggered consistent LBT | May be cancelled |
| failure | |
| triggered BFR | May be cancelled |
| triggered Sidelink Buffer | No need to cancel |
| Status Reporting | |
| procedure | |
| UL HARQ | Option 1: NDIs for all uplink HARQ processes |
| | may be set to the value 0. |
| | Option 2: HARQ retransmissions of an |
| | ongoing HARQ process on the new cell may be |
| | considered. Do not set NDIs for all uplink |
| | HARQ processes to the value 0 |
| | Whether to continue ongoing HARQ process or |
| | not (i.e. option 1 or option 2) can be indicated |
| | via RRC signaling or in L1/L2 cell change/ |
| | switch command. |
| DL HARQ | Option 1: for each DL HARQ process, the next |
| | received transmission for a TB may be |
| | considered as the very first transmission. Soft |
| | buffers for all DL HARQ processes may be |
| | flushed. Note that currently intial HARQ |
| | transmission and HARQ retransmissions for a |
| | HARQ process are from same cell. |
| | Option 2: HARQ retransmissions of an |
| | ongoing HARQ process on the new cell may be |
| | considered. |
| | Whether to continue ongoing HARQ process or |
| | not (i.e. option 1 or option 2) can be indicated |
| | via RRC signaling or in L1/L2 cell change/ |
| | switch command. |
| BFI_COUNTERs | May be reset |
| LBT_COUNTERs | May be reset |
| PHR report trigger | Option 1: PHR report is triggered. Option 2: |
| | PHR report is not triggered. |
| | Whether to perform option 1 or option 2 can be |
| | indicated via RRC signaling or in L1/L2 cell |
| | change/switch command |
| PHR periodic timer | Option 1: Timer is restarted, when the first UL |
| | resource is allocated for a new transmission |
| | upon L1/L2 control signaling activating the |
| | TCI state. Option 2: Timer is not re-started |
| | Whether to perform option 1 or option 2 can be |
| | indicated via RRC signaling or in L1/L2 cell |
| | change/switch command |

In an embodiment, a subset of TCI states indicated in operation 210 can be included in the L1/L2 switching command at operation 215. Activation of a TCI state amongst this subset may be done after the L1/L2 switching command by DCI or MAC CE. The activated TCI state is then used for PDCCH monitoring in the target cell.

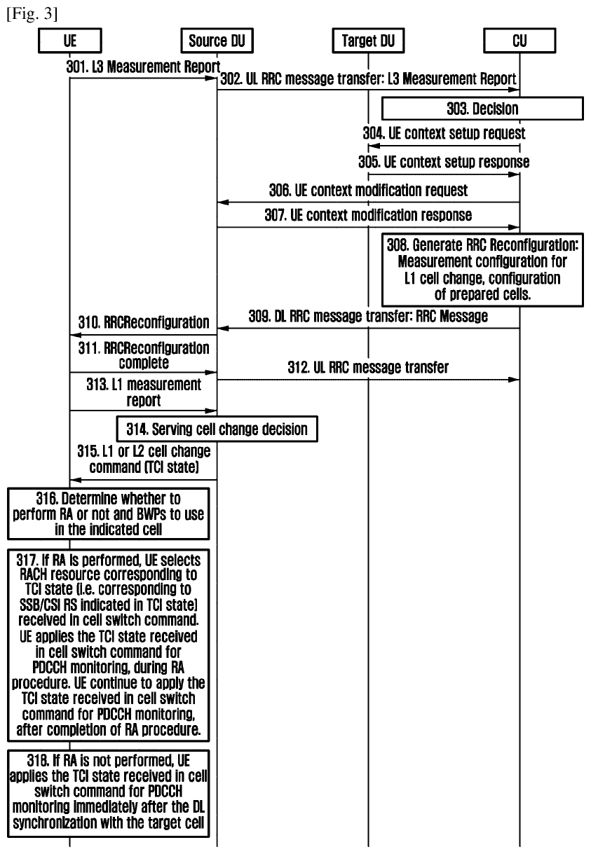

FIG. 3 illustrates an example of TCI state/BWP handing in a lower layer based mobility procedure according to an embodiment of the disclosure.

A UE may send measurement report(s) containing the measurements of serving and target cell(s) in operations 301 and 302. The measurement report may be sent to the serving cell. A serving DU (i.e., source DU) of the serving cell then may forward the report(s) to a CU.

Based on the reported measurements, the CU may identify a potential set of candidate target cells to which the UE can be handed over to, in operation 303. In this example, the CU may identify one or more candidate target cells where candidate cell is served by either the source DU or another DU (i.e., target DU) which are controlled by the same CU.

The CU may request the preparation of a candidate target cell controlled by the target DU by sending UE Context Setup Request message in, operation 304. The target DU may provide the configuration of the UE in UE Context Setup Response messages, respectively, in operation 305. Each message may include a container from DU to CU. The configuration may contain UE-specific and non-UE-specific parts. In an embodiment, operation 304 and operation 305 may not be performed if candidate target cells of the other DU are not identified in operation 303.

The CU may request the preparation of a candidate target cell controlled by the source DU by sending UE Context Modification Request message in operation 306. The source DU may provide the configuration of the UE in UE Context Modification Response message including a container from DU to CU in operation 307. The configuration may contain UE-specific and non-UE-specific parts. In an embodiment, operation 306 and operation 307 may not be performed if candidate target cells of the source DU are not identified in operation 303.

Upon receiving the UE configurations for the candidate target cell(s), the CU may generate an RRC Reconfiguration (in operation 308) to be sent to the UE in operations 309 and 310. The CU may send the configuration to the source DU which then sends the configuration to the UE. Among other information, the RRC Reconfiguration message contains at least one of: Measurement reporting configuration for L1/L2 mobility (i.e., configuration on how to report the L1 beam measurements of serving and target cells); Configuration of the prepared candidate cell(s) which the UE needs to execute when the UE receives a L1/L2 command to change the serving cell, such as random access configuration; radio bearer configurations; indication of whether to perform a PDCP re-establishment or not (per DRB or common for all); indication of whether to perform a PDCP level data recovery or not (per DRB or common for all); indication of whether to perform an RLC re-establishment or not (per DRB or RLC channel or common for all); indication of whether to perform a MAC reset or partial MAC reset or not, etc. The RRC Reconfiguration may also include firstActiveUplinkBWP and firstActiveDownlinkBWP for each prepared candidate cell(s) and a list of DL and UL BWP configurations for each prepared candidate cell(s). The RRC Reconfiguration may also include InitialUplinkBWP and InitialDownlinkBWP for each prepared candidate cell(s) and a list of DL and UL BWP configurations for each prepared candidate cell(s).

The UE may confirm the RRC Reconfiguration to the network in operations 311 and 312.

After confirming the RRC Reconfiguration to the network, the UE may start to report the L1 beam measurement of the serving cell and candidate target cells in operation 313. Based on the measurements, the serving cell may decide to trigger a cell change command in operation 314. In an example, upon determining that there is a target candidate cell having a better radio link/beam measurement than the serving cell (operation 314), e.g., L1-RSRP of target beam measurement >L1-RSRP of serving beam measurement+Offset for a time period (i.e. Time-to-Trigger (TTT) period), the serving cell may send an L1 or L2 cell change/switch command in operation 315 to trigger the cell change to the target candidate cell. In an embodiment, the L1 or L2 cell change/switch command may be a MAC CE or DCI. The cell switch/change command may include a TCI state for monitoring a PDCCH in target cell. The TCI state may be determined by the serving cell/DU or serving CU in operation 314. Alternately the TCI state may be decided by the target cell/DU and informed to the serving cell/DU. In operation 316, the UE may determine whether to perform a random access (RA) towards the target cell indicated in the L1 or L2 cell change/switch command and may determine DL/UL BWP(s) to be used for DL/UL reception/transmission in the target cell. In operation 317, if the UE determines to perform the RA, the UE may select a RACH resource corresponding to the TCI state (i.e. corresponding to SSB/CSI RS indicated in the TCI state) received in the L1/L2 cell switch command; The UE may apply the TCI state received in the L1/L2 cell switch command for PDCCH monitoring, during the RA procedure; The UE may continue to apply the TCI state received in the L1/L2 cell switch command for PDCCH monitoring, after completion of the RA procedure (UE may continue to apply the TCI state received in the L1/L2 cell switch command for PDCCH monitoring until new TCI state is received). In operation 318, if the UE determines not to perform the RA, the UE may apply the TCI state received in the L1/L2 cell switch command for the PDCCH monitoring, after or immediately after the DL synchronization with the target cell (or the UE may apply the TCI state received in the L1 or L2 cell switch command for PDCCH monitoring after receiving the cell switch command).

More specifically, operations 316 through 318 are described in detail below.
(Condition 1) In an embodiment, if a TA was maintained by the UE for the target cell before the L1/L2 cell switch change/command is received and a TAT for a TAG of the target cell is not running; or
(Condition 2)) In an embodiment, if the RRCReconfiguration message received in operation 310 or L1/L2 cell switch/change command in operation 315 includes an indication to perform an RA towards the target cell; or
(Condition 3): In an embodiment, if the L1/L2 cell switch/change command received in operation 315 does not include a TA of the target cell and the UE does not have a valid TA (e.g. TA received from the network before the L1/L2 cell switch/change command or estimated by UE) of the target cell:
   The UE may perform the RA procedure towards the target cell. The UE may select the RACH resource corresponding to the TCI state (i.e. corresponding to SSB/CSI RS indicated in the TCI state) received in the L1/L2 cell switch command. The UE may apply the TCI state received in the L1/L2 cell switch command for PDCCH monitoring, during the RA procedure.
   The UE may continue to apply the TCI state received in the L1/L2 cell switch command for PDCCH monitoring, after completion of the RA procedure (or the UE may continue to apply the TCI state received in the L1/L2 cell switch command for PDCCH monitoring until new TCI state is received).
Else (if Conditions 1, 2 and 3 are not satisfied or the UE has a valid TA for the target cell):
   The UE may apply the TCI state received in the cell switch command for PDCCH monitoring after or immediately after the DL synchronization with the target cell or after receiving the L1/L2 cell switch command.

In an embodiment, an indication to perform the RA in operation 310 may be presence of ReconfigurationwithSync IE or a new indication in SpCellConfig.

Upon receiving the L1 or L2 cell switch/change command, for the target cell (i.e. the cell to which the UE switches) the UE may determine the active DL/UL BWP as described in the embodiment of FIG. 2.

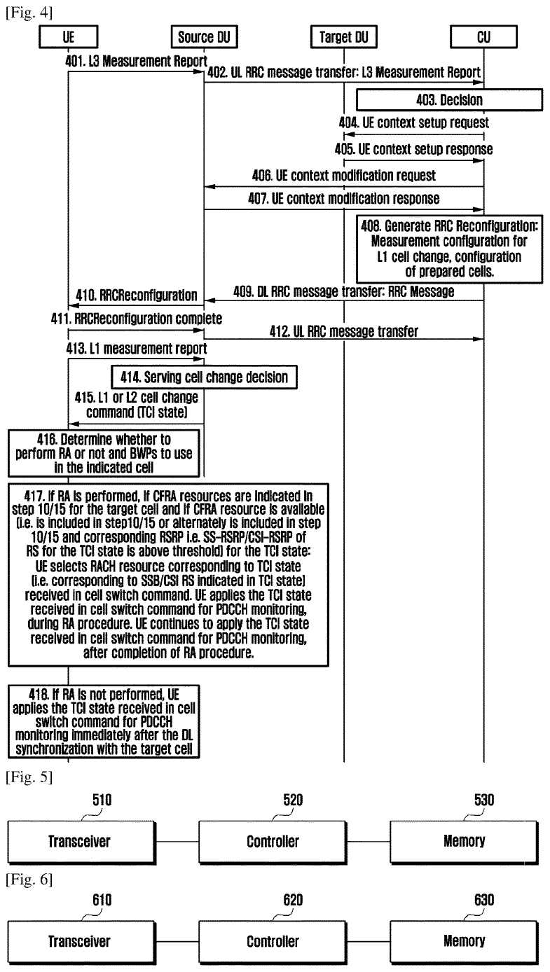

FIG. 4 illustrates an example of TCI state/BWP handing in a lower layer based mobility procedure according to an embodiment of the disclosure.

A UE may send measurement report(s) containing the measurements of serving and target cell(s) in operations 401 and 402. The measurement report may be sent to the serving cell. A serving DU (i.e., source DU) of the serving cell then may forward the report(s) to a CU.

Based on the reported measurements, the CU may identify a potential set of candidate target cells to which the UE can be handed over to, in operation 403. In this example, the CU may identify one or more candidate target cells where the candidate target cell is served by either the source DU or another DU (i.e., target DU) which are controlled by the same CU.

The CU may request the preparation of a candidate target cell controlled by the target DU by sending UE Context Setup Request message, in operation 404. The target DU may provide the configuration of the UE in UE Context Setup Response messages, respectively, in operation 405. Each message may include a container from DU to CU. The configuration may contain UE-specific and non-UE-specific parts. In an embodiment, operation 404 and operation 405 may not be performed if candidate target cells of the other DU are not identified in operation 403.

The CU may request the preparation of a candidate target cell controlled by the source DU by sending UE Context Modification Request message in operation 406. The source DU may provide the configuration of the UE in UE Context Modification Response message including a container from DU to CU in operation 407. The configuration may contain UE-specific and non-UE-specific parts. In an embodiment, operation 406 and operation 407 may not be performed if candidate target cells of the source DU are not identified in operation 403.

Upon receiving the UE configurations for the candidate target cell(s), the CU may generate an RRC Reconfiguration (in operation 408) to be sent to the UE in operations 409 and 410. The CU may send the configuration to the source DU which then sends the configuration to the UE. Among other information, the RRC Reconfiguration message contains at least one of: Measurement reporting configuration for L1/L2 mobility (i.e., configuration on how to report the L1 beam measurements of serving and target cells); Configuration of the prepared candidate cell(s) which the UE needs to execute when the UE receives a L1/L2 command to change the serving cell, such as random access configuration; radio bearer configurations; indication of whether to perform a PDCP re-establishment or not (per DRB or common for all); indication of whether to perform a PDCP level data recovery or not (per DRB or common for all); indication of whether to perform an RLC re-establishment or not (per DRB or RLC channel or common for all); indication of whether to perform a MAC reset or partial MAC reset or not, etc. The RRC Reconfiguration may also include firstActiveUplinkBWP and firstActiveDownlinkBWP for each prepared candidate cell(s) and a list of DL and UL BWP configurations for each prepared candidate cell(s). RRC Reconfiguration may also include InitialUplinkBWP and InitialDownlinkBWP for each prepared candidate cell(s) and a list of DL and UL BWP configurations for each prepared candidate cell(s).

The UE may confirm the RRC Reconfiguration to the network in operations 411 and 412.

After confirming the RRC Reconfiguration to the network, the UE may start to report the L1 beam measurement of the serving cell and candidate target cells in operation 413. Based on the measurements, the serving cell may decide to trigger a cell change command in operation 414. In an example, upon determining that there is a target candidate cell having a better radio link/beam measurement than the serving cell (operation 414), e.g., L1-RSRP of target beam measurement>L1-RSRP of serving beam measurement+Offset for a time period (i.e. Time-to-Trigger (TTT) period), the serving cell may send an L1 or L2 cell change/switch command in operation 415 to trigger the cell change to the target candidate cell. In an embodiment, the L1 or L2 cell change/switch command may be a MAC CE or DCI. The cell switch/change command may include a TCI state for monitoring a PDCCH in target cell. The TCI state may be determined by the serving cell/DU or serving CU in operation 414. Alternately the TCI state may be decided by the target cell/DU and informed to the serving cell/DU. In operation 416, the UE may determine whether to perform a random access (RA) towards the target cell indicated in the L1 or L2 cell change/switch command and may determine DL/UL BWP(s) to be used for DL/UL reception/transmission in the target cell. In operation 417, if the UE determines to perform the RA, and if CFRA resource(s) are indicated in operation 410/415 for the target cell and/or if the CFRA resource is available for the TCI state, the UE may select a RACH resource corresponding to the TCI state (i.e. corresponding to SSB/CSI RS indicated in the TCI state) received in the L1/L2 cell switch command; The UE may apply the TCI state received in the L1/L2 cell switch command for PDCCH monitoring, during the RA procedure; The UE may continue to apply the TCI state received in the L1/L2 cell switch command for PDCCH monitoring, after completion of the RA procedure (or the UE may continue to apply the TCI state received in the L1/L2 cell switch command for PDCCH monitoring until new TCI state is received). In operation 418, if the UE determines not to perform the RA, the UE may apply the TCI state received in the L1/L2 cell switch command for the PDCCH monitoring, after or immediately after the DL synchronization with the target cell (or the UE may apply the TCI state received in the L1 or L2 cell switch command for PDCCH monitoring after receiving the cell switch command).

More specifically, operations 416 through 418 are described in detail below.
(Condition 1) In an embodiment, if a TA was maintained by the UE for the target cell before the L1/L2 cell switch change/command is received and a TAT for a TAG of the target cell is not running; or
(Condition 2) In an embodiment, if the RRCReconfiguration message received in operation 410 or L1/L2 cell switch/change command in operation 415 includes an indication to perform an RA towards the target cell;
(Condition 3): In an embodiment, if the L1/L2 cell switch/change command received in operation 415 does not include a TA of the target cell and the UE does not have a valid TA (e.g. TA received from the network before the L1/L2 cell switch/change command or estimated by UE) of the target cell:
   The UE may perform the RA procedure towards the target cell.
      If CFRA resource(s) are indicated in operation 410/415 for the target cell and/or if the CFRA resource is available (i.e. is included in operation 410/415 or alternately is included in operation 410/415 and corresponding RSRP (i.e. SS-RSRP/CSI-RSRP) of RS for the TCI state is above threshold) for the TCI state,
         The UE may select the RACH resource corresponding to the TCI state (i.e. corresponding to SSB/CSI RS indicated in the TCI state) received in the cell switch command. The UE may apply the TCI state received in the cell switch command for PDCCH monitoring, during the RA procedure.
         The UE may continue to apply the TCI state received in the cell switch command for PDCCH monitoring, after completion of the RA procedure (or the UE may continue to apply the TCI state received in the L1/L2 cell switch command for PDCCH monitoring until new TCI state is received).
      Else:
         The UE may perform the RA procedure towards the target cell (during the RA, the UE may select the RACH resource corresponding to the suitable SSB or suitable SSB/CSI RS in case of CFRA).
         The UE may apply the TCI state received in the cell switch command for PDCCH monitoring, after completion of the RA procedure.
Else (if Conditions 1, 2, and 3 are not satisfied or the UE has a valid TA for the target cell):
   The UE may apply the TCI state received in the cell switch command for PDCCH monitoring after or immediately after the DL synchronization with the target cell or after receiving the L1/L2 cell switch command.

In an embodiment, the indication to perform the RA in operation 410 may be presence of ReconfigurationwithSync IE or a new indication in SpCellConfig

Upon receiving the L1 or L2 cell switch/change command, for the target cell (i.e. the cell to which the UE switches) the UE may determine the active DL/UL BWP as described in the embodiment of FIG. 2.

Alternatively, the following procedure may be applied to operations 416 through 418.
(Condition 1) In an embodiment, if a TA was maintained by the UE for the target cell before the L1/L2 cell switch change/command is received and a TAT for a TAG of the target cell is not running; or
(Condition 2) In an embodiment, if the RRCReconfiguration message received in operation 410 or L1/L2 cell switch/change command in operation 415 includes an indication to perform an RA towards the target cell;
(Condition 3): In an embodiment, if the L1/L2 cell switch/change command received in operation 415 does not include a TA of the target cell and the UE does not have a valid TA (e.g. TA received from the network before the L1/L2 cell switch/change command or estimated by UE) of the target cell:
   The UE may perform the RA procedure towards the target cell.
      If the RS in the TCI state is a CSI-RS and CFRA resource(s) are available (i.e. is included in operation 410/415 or alternately is included in operation 410/415 and corresponding CSI-RSRP is above threshold) for that CSI-RS; or
      If the RS in the TCI state is an SSB:
         The UE may select the RACH resource corresponding to the TCI state (i.e. corresponding to SSB/CSI RS indicated in the TCI state) received in the cell switch command. The UE may apply the TCI state received in the cell switch command for PDCCH monitoring, during the RA procedure.
         The UE may continue to apply the TCI state received in the cell switch command for PDCCH monitoring, after completion of the RA procedure (or the UE may continue to apply the TCI state received in the L1/L2 cell switch command for PDCCH monitoring until new TCI state is received).
      Else:
         The UE may perform the RA procedure towards the target cell (during the RA, the UE may select the RACH resource corresponding to the suitable (i.e. RSRP of SSB is above a threshold or any SSB if none of them is above threshold) SSB in case of CBRA or suitable (i.e. RSRP of SSB/CSI RS is above a threshold) SSB/CSI RS in case of CFRA).
         The UE may apply the TCI state received in the cell switch command for PDCCH monitoring, after completion of the RA procedure (or the UE may continue to apply the TCI state received in the L1/L2 cell switch command for PDCCH monitoring until new TCI state is received).
Else (if Conditions 1, 2, and 3 are not satisfied or the UE has a valid TA for the target cell):
   The UE may apply the TCI state received in the cell switch command for PDCCH monitoring after or immediately after the DL synchronization with the target cell or after receiving the L1/L2 cell switch command.

In an embodiment, In case the DL and UL TCI states are separately indicated in the L1/L2 cell switch command, the TCI state described in the embodiments of FIGS. 2 to 4 refers to a DL TCI state.

FIG. 5 illustrates a block diagram of a terminal according to an embodiment of the disclosure.

Referring to FIG. 5, a terminal includes a transceiver 510, a controller 520 and a memory 530. The controller 520 may refer to a circuitry, an application-specific integrated circuit (ASIC), or at least one processor. The transceiver 510, the controller 520 and the memory 530 are configured to perform the operations of the UE illustrated in the figures, e.g. FIGS. 1 to 4, or described above. Although the transceiver 510, the controller 520 and the memory 530 are shown as separate entities, they may be realized as a single entity like a single chip. Alternatively, the transceiver 510, the controller 520 and the memory 530 may be electrically connected to or coupled with each other.

The transceiver 510 may transmit and receive signals to and from other network entities, e.g., a base station.

The controller 520 may control the UE to perform functions according to one of the embodiments described above.

For example, the controller 520 is configured to receive, from a base station via the transceiver 510, a control message including a configuration of a target cell for a lower layer based mobility, receive, from the base station via the transceiver 510, an LTM cell change command to switch to the target cell, the LTM cell change command including information on a TCI state, and upon determining to perform a random access procedure to the target cell, select a RACH resource corresponding to the TCI state and apply the TCI state for a PDCCH monitoring during the random access procedure.

In an embodiment, the operations of the terminal may be implemented using the memory 530 storing corresponding program codes. Specifically, the terminal may be equipped with the memory 530 to store program codes implementing desired operations. To perform the desired operations, the controller 520 may read and execute the program codes stored in the memory 530 by using a processor or a central processing unit (CPU).

FIG. 6 illustrates a block diagram of a base station according to an embodiment of the disclosure.

Referring to FIG. 6, a base station includes a transceiver 610, a controller 620 and a memory 630. In one embodiment, the base station may be a CU or a DU in the split gNB structure as described above. In one embodiment, the base station may include at least one of a CU, a first DU (i.e., source/serving DU), and a second DU (i.e., target DU) in the split gNB structure as described above. The transceiver 610, the controller 620 and the memory 630 are configured to perform the operations of the network (e.g., gNB) illustrated in the figures, e.g. FIGS. 1 to 4, or described above. Although the transceiver 610, the controller 620 and the memory 630 are shown as separate entities, they may be realized as a single entity like a single chip. The transceiver 610, the controller 620 and the memory 630 may be electrically connected to or coupled with each other.

The transceiver 610 may transmit and receive signals to and from other network entities, e.g., a terminal.

The controller 620 may control the base station to perform functions according to one of the embodiments described above. The controller 620 may refer to a circuitry, an ASIC, or at least one processor.

For example, the controller 620 is configured to transmit, to a terminal via the transceiver 610, a control message including a configuration of a target cell for a lower layer based mobility, and transmit, to the terminal via the transceiver 610, an LTM cell change command to switch to the target cell, the LTM cell change command including information on a TCI state. If a random access procedure to the target cell is performed, the TCI state corresponds to a RACH resource for the random access procedure and the TCI state is applied for a PDCCH monitoring during the random access procedure.

In an embodiment, the operations of the base station may be implemented using the memory 630 storing corresponding program codes. Specifically, the base station may be equipped with the memory 630 to store program codes implementing desired operations. To perform the desired operations, the controller 620 may read and execute the program codes stored in the memory 630 by using a processor or a CPU.

While the disclosure has been shown and described with reference to various embodiments thereof, it will be understood by those skilled in the art that various changes in form and details may be made therein without departing from the spirit and scope of the disclosure as defined by the appended claims and their equivalents.

As described above, embodiments disclosed in the specification and drawings are merely used to present specific examples to easily explain the contents of the disclosure and to help understanding, but are not intended to limit the scope of the disclosure. Accordingly, the scope of the disclosure should be analyzed to include all changes or modifications derived based on the technical concept of the disclosure in addition to the embodiments disclosed herein.

1-15. (canceled)

16. A method performed by a terminal in a wireless communication system, the method comprising:
receiving, from a base station, configuration information on a candidate cell for a layer 1 or layer 2 triggered mobility (LTM);
receiving, from the base station, an LTM cell switch command including information on a transmission configuration indicator (TCI) state for the candidate cell; and
in case that a random access procedure for the candidate cell is performed, applying the TCI state for downlink reception on the candidate cell after completion of the random access procedure.

17. The method of claim 16, wherein the LTM cell switch command is received in a medium access control (MAC) control element (CE).

18. The method of claim 16, wherein the configuration information includes first active uplink bandwidth part (BWP) information and first active downlink BWP information.

19. The method of claim 18, further comprising:
after receiving the LTM cell switch command, determining an active uplink BWP for the candidate cell and an active downlink BWP for the candidate cell, based on the first active uplink BWP information and the first active downlink BWP information.

20. A method performed by a base station in a wireless communication system, the method comprising:
transmitting, to a terminal, configuration information on a candidate cell for a layer 1 or layer 2 triggered mobility (LTM); and
transmitting, to the terminal, an LTM cell switch command including information on a transmission configuration indicator (TCI) state for the candidate cell; and
in case that a random access procedure for the candidate cell is performed, applying the TCI state for downlink transmission on the candidate cell after completion of the random access procedure.

21. The method of claim 20, wherein the LTM cell switch command is transmitted in a medium access control (MAC) control element (CE).

22. The method of claim 20, wherein the configuration information includes first active uplink bandwidth part (BWP) information and first active downlink BWP information.

23. The method of claim 23, wherein the first active uplink BWP information indicates an active uplink BWP for the candidate cell to be used after transmitting the LTM cell switch command and the first active downlink BWP information indicates an active downlink BWP for the candidate cell to be used after transmitting the LTM cell switch command.

24. A terminal in a wireless communication system, the terminal comprising:
a transceiver; and
a controller configured to:
receive, from a base station via the transceiver, configuration information on a candidate cell for a layer 1 or layer 2 triggered mobility (LTM),
receive, from the base station via the transceiver, an LTM cell switch command including information on a transmission configuration indicator (TCI) state for the candidate cell, and
in case that a random access procedure for the candidate cell is performed, apply the TCI state for downlink reception on the candidate cell after completion of the random access procedure.

25. The terminal of claim 24, wherein the LTM cell switch command is received in a medium access control (MAC) control element (CE).

26. The terminal of claim 24, wherein the configuration information includes first active uplink bandwidth part (BWP) information and first active downlink BWP information.

27. The terminal of claim 26, wherein the controller is further configured to:
after receiving the LTM cell switch command, determine an active uplink BWP for the candidate cell and an active downlink BWP for the candidate cell, based on the first active uplink BWP information and the first active downlink BWP information.

28. A base station in a wireless communication system, the base station comprising:
a transceiver; and
a controller configured to:
transmit, to a terminal via the transceiver, configuration information on a candidate cell for a layer 1 or layer 2 triggered mobility (LTM), and
transmit, to the terminal via the transceiver, an LTM cell switch command including information on a transmission configuration indicator (TCI) state for the candidate cell, and
in case that a random access procedure for the candidate cell is performed, apply the TCI state for downlink transmission on the candidate cell after completion of the random access procedure.

29. The base station of claim 28, wherein the LTM cell switch command is transmitted in a medium access control (MAC) control element (CE).

30. The base station of claim 28, wherein the configuration information includes first active uplink bandwidth part (BWP) information and first active downlink BWP information.

31. The base station of claim 30, wherein the first active uplink BWP information indicates an active uplink BWP for the candidate cell to be used after transmitting the LTM cell switch command and the first active downlink BWP information indicates an active downlink BWP for the candidate cell to be used after transmitting the LTM cell switch command.
